(19) United States
(12) Patent Application Publication
(10) Pub. No.: US 2026/0005419 A1
(43) Pub. Date: Jan. 1, 2026

(54) WIDEBAND MILLIMETER-WAVE QUADRATURE COUPLER WITH CONSTANT BANDWIDTH SCALABILITY

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/757,226

(22) Filed: Jun. 27, 2024

(51) Int. Cl. H01P 5/18; H01P 5/22

(52) U.S. Cl. CPC H01P 5/184; G06F 9/06; H01P 5/227

(57) ABSTRACT

The technology described herein is directed towards a wide-bandwidth, high-frequency (e.g., millimeter wave) quadrature coupler. One implementation of the quadrature coupler is passive and compact, is designed with a single top metallization layer, and does not require any interconnecting layer. The planar design can include four ports coupled to the four sides of a rhombus/diamond metal plane portion, with cross-shaped slots that intersect in the center of the metal plane portion for efficiently routing E- and H-fields to other ports. Design tweaks can change the radio frequency (RF) characteristics of the quadrature coupler, including, for example, scaling the quadrature coupler dimensions to establish the center frequency, while retaining constant bandwidth. Other tweaks can be made to the dimensions of the cross-shaped slots. The design facilitates integration with other planar RF technologies.

### BACKGROUND

The telecommunications industry is moving towards communications based on higher frequencies to accommodate the soaring demand for bandwidth. For example, beamforming networks have the need for various radio frequency (RF) components, including quadrature couplers. A quadrature coupler, sometimes referred to as a hybrid coupler or a ninety-degree) (90°) coupler, is a passive four-port device that offers signal splitting and combining, with 90° phase difference between two ports. Quadrature couplers, used in phase-sensitive applications like Butler matrices and antenna feed networks, encounter significant challenges at millimeter-wave (mmWave) frequencies.

At mmWave frequencies, the bandwidth limitation of traditional quadrature couplers remains a significant issue. As the frequency increases, the wavelength decreases, leading to pronounced effects of parasitics, material imperfections, and fabrication tolerances, which in turn narrow the operational bandwidth and affect overall system performance.

### BRIEF DESCRIPTION OF THE DRAWINGS

The technology described herein is illustrated by way of example and not limited in the accompanying figures in which like reference numerals indicate similar elements and in which:

FIG. 1 is top view representation of an example layout of a planar quadrature coupler, showing various design dimensions, in accordance with various embodiments and implementations of the subject disclosure.

FIG. 2 is a three-dimensional (3D) perspective top view of a model of the quadrature coupler corresponding to FIG. 1, in accordance with various embodiments and implementations of the subject disclosure

FIG. 3 is top view representation of an example layout of a planar quadrature coupler, showing various design dimensions, in accordance with various embodiments and implementations of the subject disclosure.

FIG. 4 is a block diagram showing an example system for determining design parameters for a millimeter-wave quadrature coupler, in accordance with various embodiments and implementations of the subject disclosure.

FIG. 5 is a three-dimensional (3D) perspective top view showing simulation of the E-field based on a model of the quadrature coupler corresponding to FIGS. 1-3, in accordance with various embodiments and implementations of the subject disclosure

FIG. 6 is a graphical representation of a simulation response of the example quadrature coupler designed with a constant 4 GHz bandwidth and a 28 GHz center frequency, showing scattering parameters (S-parameters) for frequency versus magnitude, in accordance with various example embodiments and implementations of the subject disclosure.

FIG. 7 is a graphical representation of a simulation response of the example quadrature coupler designed with a constant 4 GHz bandwidth and a 28 GHz center frequency, showing S-parameters for frequency versus phase response, in accordance with various example embodiments and implementations of the subject disclosure.

FIG. 8 is a graphical representation of a simulation response of the example quadrature coupler designed with a constant 4 GHz bandwidth and a 27 GHz center frequency, showing S-parameters for frequency versus magnitude, in accordance with various example embodiments and implementations of the subject disclosure.

FIG. 9 is a graphical representation of a simulation response of the example quadrature coupler designed with a constant 4 GHz bandwidth and a 27 GHz center frequency, showing S-parameters for frequency versus phase response, in accordance with various example embodiments and implementations of the subject disclosure.

FIG. 10 is a graphical representation of a simulation response of the example quadrature coupler designed with a constant 4 GHz bandwidth and a 29 GHz center frequency, showing S-parameters for frequency versus magnitude, in accordance with various example embodiments and implementations of the subject disclosure.

FIG. 11 is a graphical representation of a simulation response of the example quadrature coupler designed with a constant 4 GHz bandwidth and a 29 GHz center frequency, showing S-parameters for frequency versus phase response, in accordance with various example embodiments and implementations of the subject disclosure.

FIG. 12 is a representation of a schematic of a Butler matrix beamforming network that includes example quadrature couplers as described herein, in accordance with various example embodiments and implementations of the subject disclosure.

FIGS. 13 and 14 comprise a flow diagram showing example operations related to determining design parameters for a quadrature coupler based on input parameters, and configuring the quadrature coupler to be implemented based on the design parameters, in accordance with various example embodiments and implementations of the subject disclosure.

### DETAILED DESCRIPTION

The technology described herein is generally directed towards a quadrature coupler including a top metallization layer with four ports, a metal plane, and a cross-shaped opening in the metal plane, in which the cross-shaped opening includes a first slot and second slot that intersect. In general, the slots efficiently channel E- and H-fields to the ports, overcoming common issues experienced by other quadrature coupler designs, including high loss and inadequate field distribution. Significantly, the quadrature coupler described herein features a broadband capability with a constant bandwidth, significantly simplifying frequency scaling for designers. This allows for the quadrature coupler as described herein to be easily adjusted to desired frequencies without the cumbersome, computationally heavy optimization required by other components, which can take several hours to days. In addition, the technology described herein does not involve any stringent dimensional variabilities, thus reducing the cost of manufacturing significantly.

In one implementation, a compact, passive quadrature circuit is designed with a single-top-layer metal configuration, eliminating the need for any additional interconnect layers. This distinguishes the technology described herein from commercially available couplers and designs proposed by other researchers. The example design described herein is scalable, and demonstrates low insertion loss at millimeter wave (mmWave) frequencies, achieved through the use of the cross-shaped slots in the coupler's center. By solving the many problems associated with commercially available couplers and those designed by other researchers, such as scalability issues, high insertion losses, and complex optimization processes, the technology described herein offers a streamlined, efficient alternative, and ultra-low-cost solution for mmWave circuits and systems.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” “between” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

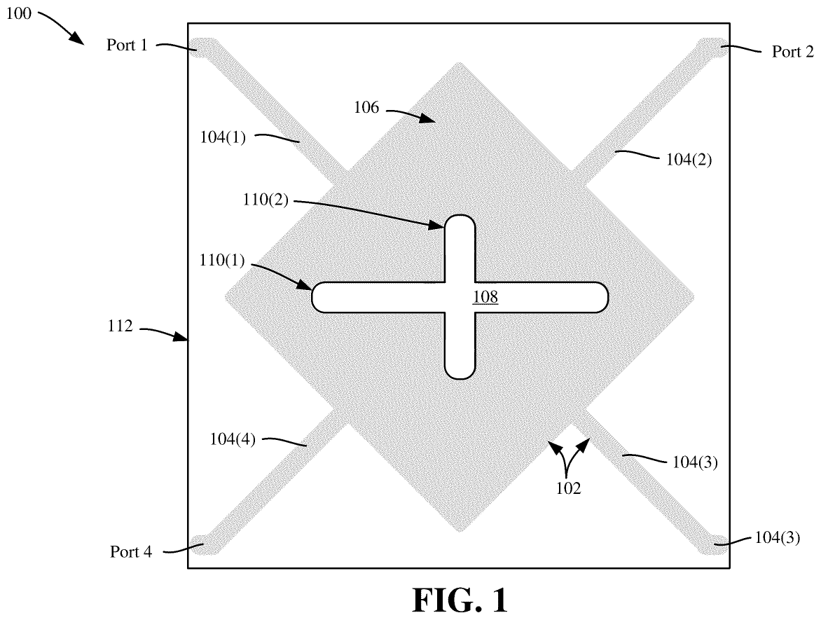

FIG. 1 shows a top view of an example wideband quadrature coupler 100 designed using a cross-shaped slot geometry, in which the top metallization layer 102 (e.g., the shaded material) is fabricated via a single-layer metal configuration. Four ports (Port 1-Port 4) including corresponding microstrip lines 104(1)-104(4) are coupled to a metallic plane 106, a portion of the top metallization layer 102. As in general with quadrature couplers, the Port 1 is the input port, the Port 2 is the through port, the Port 3 is the coupled port, and the Port 4 is the isolated port.

The metallic plane 106 includes an opening 108, that is, there is no metal at the area corresponding to the opening 108. The opening 108 includes two slots 110(1) and 110(2).

In one implementation, the four ports (Port 1-Port 4)/microstrip lines 104(1)-104(4) are coupled to the four sides of the metallic plane 106, which is rectangular and substantially square. The slots 110(1) and 110(2) extend towards the corners of the metallic plane 106, substantially perpendicular to one another and diagonal relative to the microstrip lines 104(1)-104 (4), and intersect substantially at the center of the metallic plane.

Typically, one of the slots (e.g., 110(1)) can be longer than the other slot (e.g., 110(2)). In general, the angles of the slots relative to the rhombus/diamond are plus and minus forty-five degrees, otherwise the quadrature coupler 100 will not work as well, because of the E-field and H-field disruption.

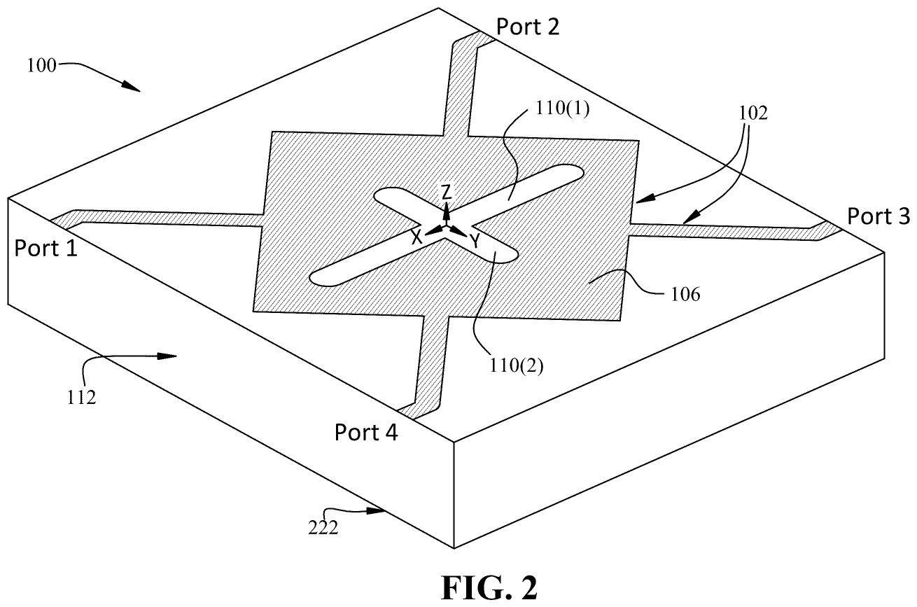

FIG. 2 is a three-dimensional perspective view representation of the example quadrature coupler 100, in which the top metallization layer 102 is on a substrate 220. Beneath the substrate is a bottom metallization layer 222 that serves as a ground plane. The four ports (Port 1-Port 4), the square metal plane portion 106 and the slots 110(1) and 110(2) are labeled in FIG. 2, as are the X, Y and Z axes.

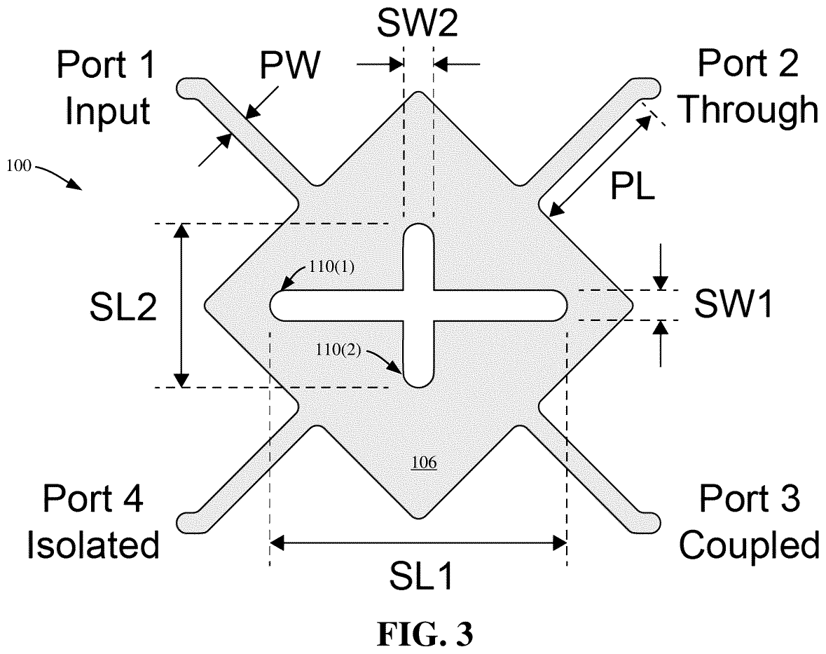

FIG. 3 shows design variables of the quadrature coupler 100, for the rhombus/diamond shaped geometry of FIG. 1 with the two cross-shaped slots in the center. The first slot 110(1) has width SW1 and length SL1, while the second slot 110(2) has a width SW2 and length SL1. In general, a quadrature coupler needs four ports, namely, port 1 as an input port, port 2 for through signal, port 3 for coupled signal output with 90° phase difference, and an isolated port 4. The ports' length PL and width PW are chosen in one implementation to have the characteristic impedance of 50 Ω but can be varied to accommodate any other impedance (such as if the coupler is required right after an antenna). Exact dimensions are not provided, as this design is scalable and the designer only needs to scale the size of the overall structure to change the frequency band.

Changing the slot width(s) and/or length(s) allow a designer to optimize the RF matching. Note that just scaling the quadrature coupler (with proportional overall dimensions) will not impact the RF matching. However, if the slot length(s) and/or slot width(s) are scaled differently relative to the overall scaling size, the quadrature coupler can be optimized for certain substrate materials. This allows fine tuning the S-parameters (scattering parameters). More than −15 dB of return loss and 3 dB of coupling are desired. Changing the slot length(s) and/or slot width(s) also can increase or decrease the bandwidth limits, to an extent.

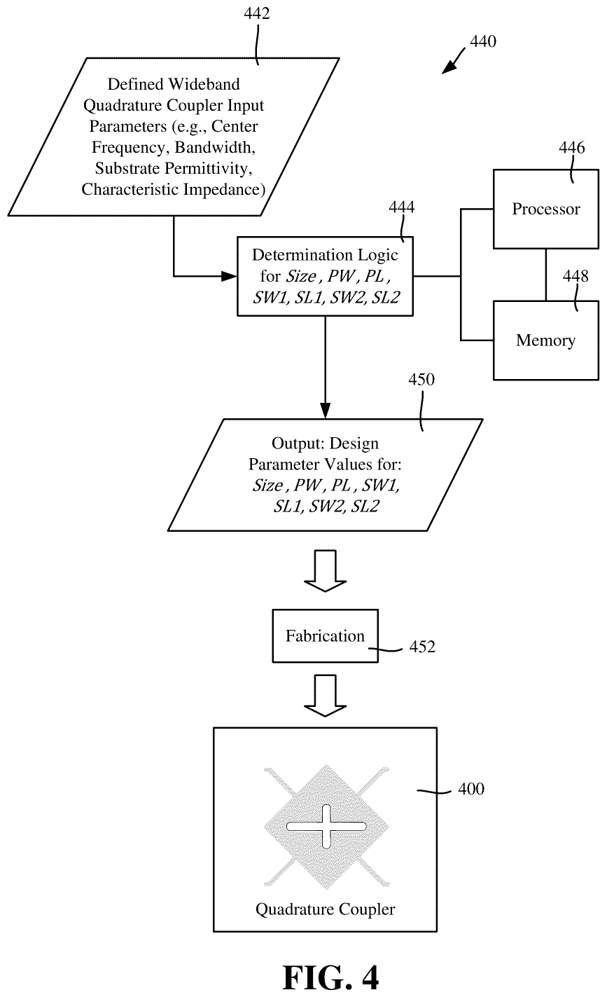

FIG. 4 shows a generalized block diagram of an example system 440 for designing a compact, single layer wideband passive quadrature coupler 400 based on defined needs of an application, represented by input parameters 442, including, but not limited to the desired bandwidth, center frequency, substrate permittivity, and characteristic impedance Z₀. Determination logic 444, e.g., executed via at least one processor 446 and memory 448, can determine the output design parameter values 450 for the dimensions and other factors for a wideband quadrature coupler 400 that achieves these input parameters 442. These include the overall scaling size, which determines the center frequency/and/or bandwidth, at least in part. The slot lengths SL1 and SL2, and slot widths SW1 and SW2 can be used to determine other RF characteristics of the quadrature coupler 400, including optimizing/fine-tuning the S-parameters for certain substrate materials, and increase or decrease the bandwidth limits, at least to an extent. The ports' length and width (PL and PW) values (to meet the desired characteristic impedance Z₀) can be determined as part of the output design parameter values 440. Once the parameters are optimized and the quadrature coupler is tuned as desired, a user only need to scale the overall quadrature coupler.

Based on these output design parameter values 450, fabrication (represented by block 452) can be performed in a straightforward manner by any suitable technique that fabricates the single top metallization layer on the substrate, and fabricates the bottom metallization layer beneath the substrate. The result is a compact, relatively low-cost quadrature coupler 400 as described herein that provides significant benefits in high-frequency (e.g., mmWave) applications.

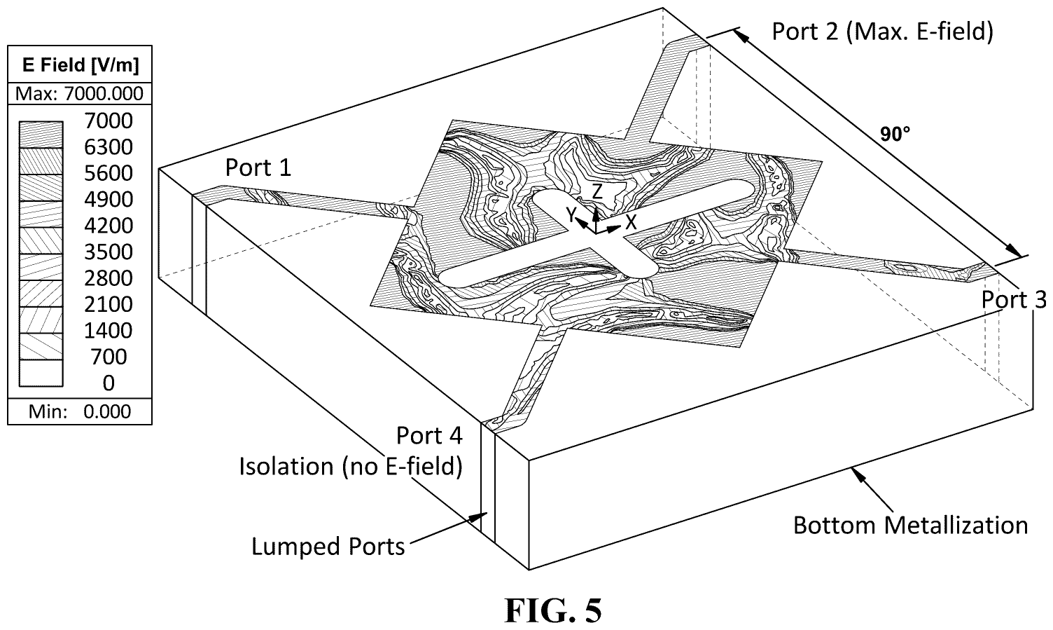

FIG. 5 shows simulation of the E-field based on the example coupler design of FIGS. 1-3, highlighting signal propagation towards Port 2 and Port 3, while the isolated port (Port 4) is not receiving any signal. The compact quadrature coupler 100 described herein is thus highly appropriate for mmWave systems and technologies such as 5G and beyond; the compact design reduces material and manufacturing costs, while enabling the creation of more sophisticated, higher-density array architectures that are needed for the high-speed, high-capacity demands of future wireless communication systems.

Note that the single top metallization layer quadrature circuit design described herein is in contrast to a typical quadrature circuit, which typically have a very narrow bandwidth in the range of only a few megahertz, which limits their use for broadband applications, such as 5G-advanced or 6G applications where significantly larger bandwidth is needed. Indeed, as the telecommunications industry advances towards higher frequencies to meet the increasing demand for bandwidth, the design and implementation of RF components pose new challenges. Among these, quadrature couplers, needed for phase-sensitive applications such as RF mixers, modulators, and antenna feed networks, face significant limitations. Traditional quadrature couplers, while effective at lower frequencies, are unable to adequately maintain performance across the wide bandwidths needed by millimeter-wave applications.

The development of hybrid couplers suitable for mmWave applications poses its own set of challenges, including the need for integration with planar technologies, miniaturization, and maintaining high performance over a wide frequency range. As the frequency increases, the wavelength decreases, leading to pronounced effects of parasitics, material imperfections, and fabrication tolerances, which in turn narrow the operational bandwidth and affect the overall system performance. Among the narrow operational bandwidth limitation, other limitations include high insertion loss at poor isolation, and degraded phase and amplitude balance, which severely impact the efficiency and reliability of high-frequency wireless systems. At high frequencies, the inherent physical and electrical constraints of quadrature couplers limit their application. These limitations hold back the potential of mmWave technologies, and also limit the scalability and versatility of communication systems.

The fundamental topology for the implementation of a conventional quadrature coupler with characteristic impedance Z0 can have a conventional microstrip configuration; however, both the series and shunt branches of the conventional device are required to have a length of λ/4. While this implementation approach is straightforward, it presents a significant limitation regarding bandwidth. The reason for this limitation is that the line lengths achieve λ/4 only at a specific frequency. Such quadrature couplers are thus favored in low-frequency applications, including cellular phones, where a narrow bandwidth of a few MHz suffices. However, for mmWave systems, this basic design approach is inadequate due to the inherent losses at high frequencies and the requirement for a broader bandwidth.

Commercially-available hybrid couplers offer several advantages and disadvantages that impact their application in RF systems. On the positive side, commercially-available hybrid couplers are readily available, whereby designers can easily incorporate them into various systems without the need for custom development, thereby reducing lead times. Additionally, they tend to exhibit low loss, enhancing system efficiency and performance, and are generally reliable, ensuring stable operation over their intended lifespan. However, these benefits are counterbalanced by several drawbacks, including that hybrid couplers are often expensive, which can significantly increase the cost of systems in which they are used. For example, in the context of an 8×8 beamforming network using a Butler matrix, the requirement for multiple quadrature couplers, each potentially costing approximately US $1,500, can make the system prohibitively expensive and impractically bulky; an 8×8 beamforming network using a Butler matrix requires twelve quadrature couplers, which drives the cost of the device by an additional US $18,000.

Furthermore, traditional hybrid couples may suffer from low isolation, and sometimes exhibit high phase imbalance over the frequency range, which can degrade the performance of RF systems. Their relatively large size and bulkiness also present challenges in terms of integration, and can limit their use in compact or portable applications.

Researchers have proposed various solutions to address the challenges associated with the design of quadrature couplers. For instance, a multi-layer implementation has been attempted, but necessitates a complex fabrication process that includes glass processing and etching, as well as the use of non-standard materials. This approach not only potentially increases manufacturing costs but may also result in lower yields. Additionally, this approach is plagued by suboptimal RF performance at mmWave frequencies, characterized by significant issues such as high insertion loss, inadequate return loss, and a limited bandwidth of merely 500 megahertz. One other ultra-wideband quadrature coupler featured negligible loss and provided exceptional performance and a compact design footprint, however, it was fabricated using a superconducting microfabrication process, which is not commercially available, and moreover, the device operates effectively only at cryogenic temperatures suitable for quantum hardware, but demonstrated inferior RF performance at room temperature.

To simulate in a 3D field solver, ports need to be defined as shown in FIG. 5. One implementation chose lumped ports with 50 Ω characteristic impedance and 30 dBm of input RF power. A scalable radiation box was designed to accommodate the study of E- and H-field. For this design, a standard Rogers 4000 series substrate was chosen, but for different substrate materials such as FR4 laminates, alumina, silicon, glass, or any other dielectric material, the quadrature coupler can be optimized by only varying the slot width and length of both slots, which can be in addition to varying port width and port length, and which can be parametrized to achieve desired performance for a specific dielectric constant and loss tangent.

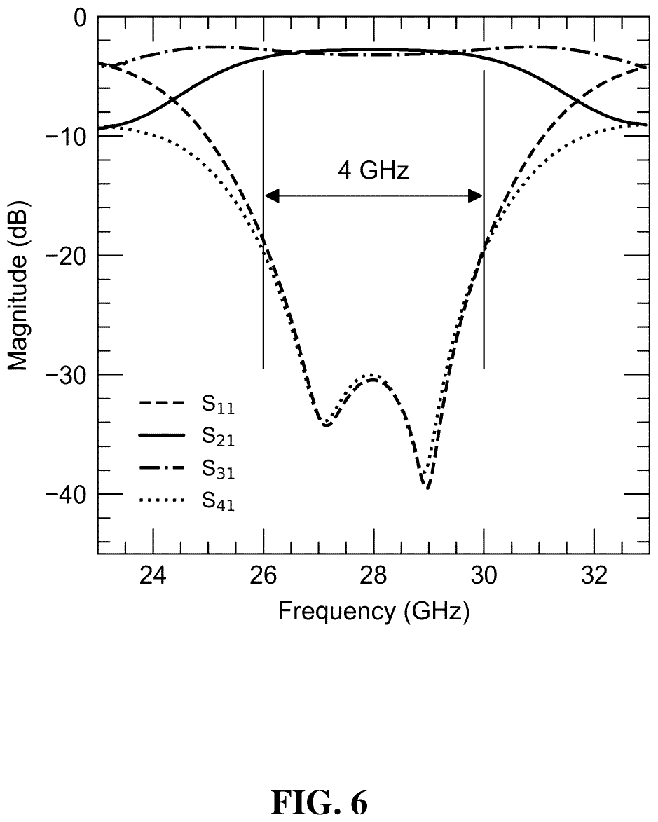

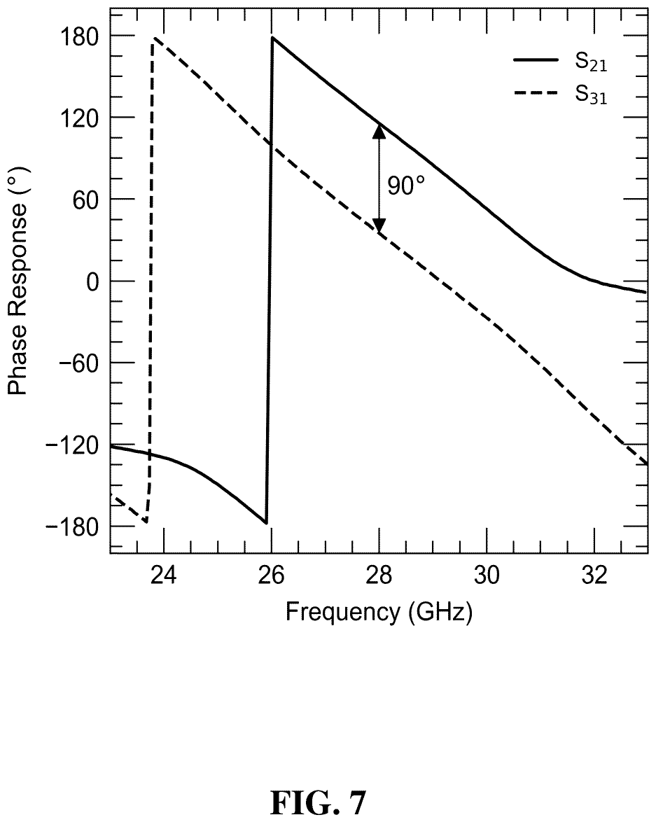

The EM simulation response (magnitude and phase response) of the quadrature coupler is shown in FIGS. 6 and 7 demonstrating excellent RF performance over 4 GHz bandwidth with 28 GHz center frequency. The S-parameter magnitudes for varying frequencies are shown in FIG. 6. The phase response (FIG. 7) shows phase profile lines over the band with constant 90° phase different between port 2 and 3. The bandwidth of the quadrature coupler is dictated when the S₂₁ and S₃₁ is 3 dB (a 50:50 split).

A low insertion loss can be seen in FIG. 6 from S₂₁, the signal flowing from port 1 to 2, and S₃₁, the signal flowing from port 1 to 3. The Sun is below 20 dB over the band, iterating a near ideally matched circuit with no reflections, and S₄₁ better than −20 dB, demonstrating better isolation. In fact, in the design described herein, the isolation is better than 22 dB over the band, in contrast to commercially available couplers that have isolation of 17 dB. The through (port 2) and coupled (port 3) show strong 3 dB coupling, which is a highly desirable trait of a quadrature coupler; to reiterate, a 3 dB difference means equal split of the signal (50:50) between two ports, and an insertion loss is any loss above 3 dB value. In the design described herein, the loss of the coupler is lower than 0.5 dB over the entire band.

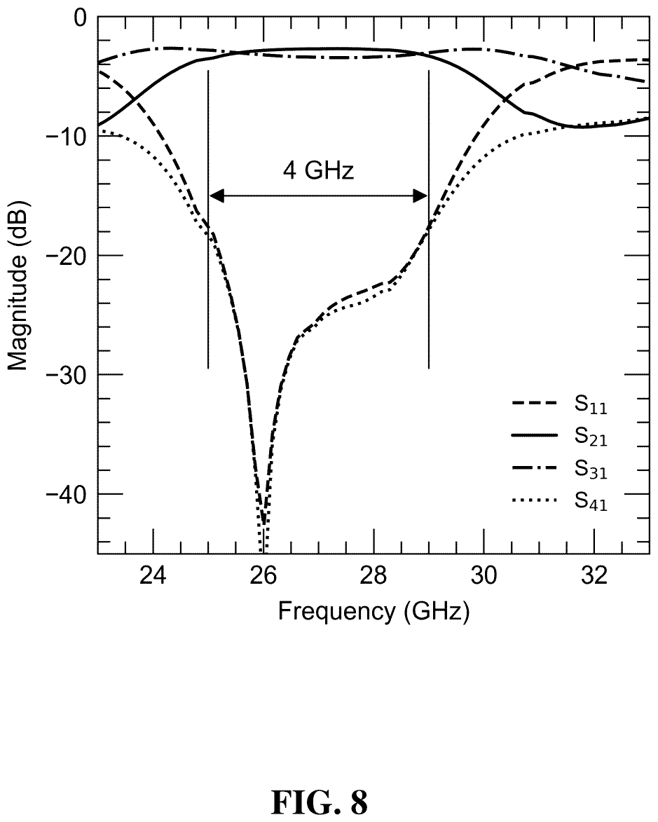

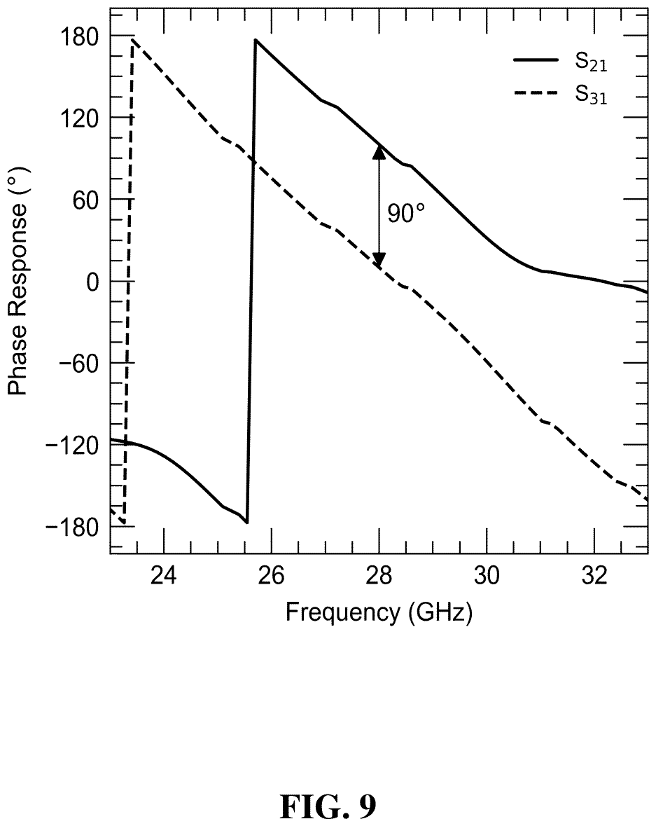

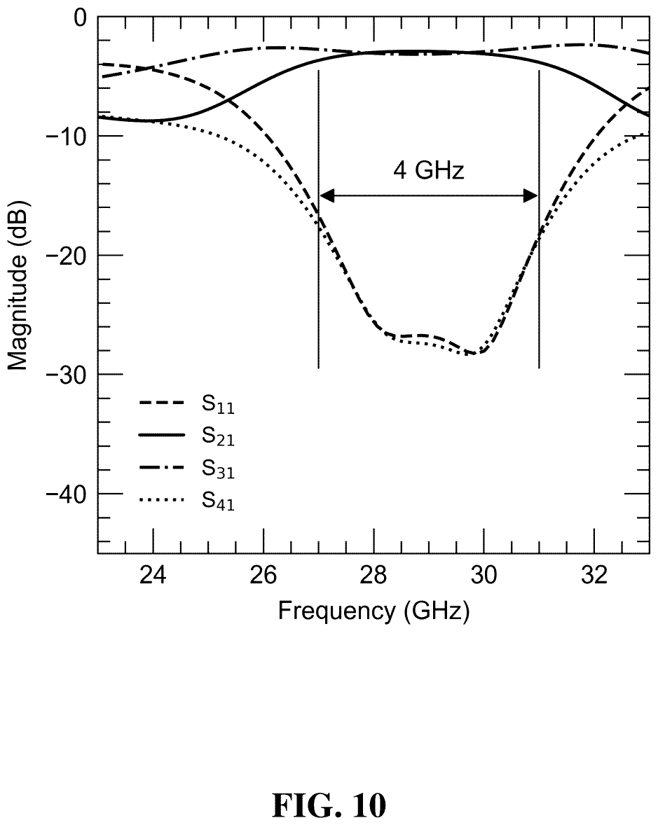

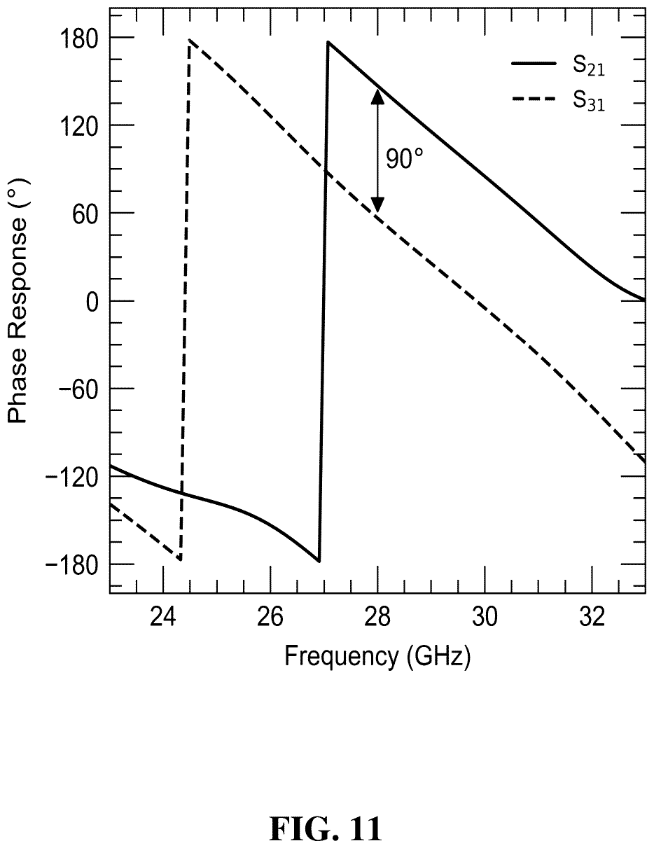

When the coupler is scaled a bit larger than the designed X-Y dimensions corresponding to FIGS. 6 and 7, the center frequency can be tuned while keeping the bandwidth consistent, as shown in FIGS. 8 and 9. Conversely, when the X-Y dimensions are shrunken, the center frequency is increased from 28 to 29 GHz, while still keeping the constant 4 GHZ bandwidth and balanced 90° phase difference as shown in FIGS. 10 and 11

Turning to some use case examples for quadrature couplers, quadrature couplers are often used in balanced mixers and modulators to ensure that signals are combined or split with a 90-degree phase difference. Quadrature couplers based on the example design described herein can achieve high performance in terms of linearity and suppression of unwanted signals.

Quadrature couplers are used in antenna feeding networks. More particularly, in complex antenna systems, such as phased arrays, quadrature couplers based on the example design described herein can be used to feed antennas in a manner that allows for beam steering and shaping by controlling the phase and amplitude of the signal going to each antenna element.

With respect to signal distribution and combining, quadrature couplers based on the example design described herein can be used to evenly split an input signal into two output signals with a 90-degree phase difference between them, or combine two signals while maintaining this phase difference. This is useful in applications requiring precise phase control and signal routing, such as in certain radar and communication systems.

For phase shifters, adjusting the impedance seen at the ports of a quadrature coupler based on the example design described herein can create a phase shift in the signal, which is useful for phased array antennas and other applications requiring precise control over the signal phase. With respect to directional couplers, quadrature couplers as described herein can be used as a specific type of directional coupler used for measuring the power flowing in a transmission line, sampling signals without disturbing the main flow, and for SWR (Standing Wave Ratio) measurements.

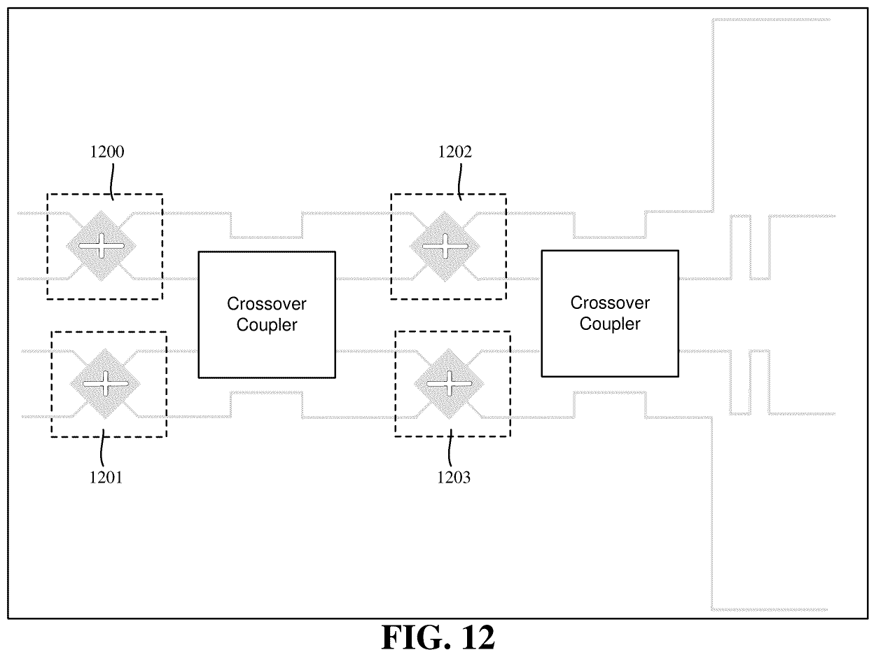

With respect to mm Wave quadrature (hybrid) coupler uses, in mmWave communication systems, including 5G and beyond, quadrature couplers based on the example design described herein can be used in the deployment of 5G cellular networks, especially for beamforming in base stations and small cells. These couplers enable the precise control of signal phase and amplitude needed for directing beams towards users and away from interference. FIG. 12 shows quadrature couplers 1200-1203 as described herein incorporated into a Butler matrix beamforming network.

In advanced driver-assistance systems (ADAS) and autonomous vehicles, mm Wave hybrid (quadrature) couplers as described herein can be used in automotive radar systems operating in the 24 GHZ, 77 GHz, and 79 GHz bands for object detection, speed measurement, and collision avoidance.

For satellite communication systems, especially those operating in the Ka-band and above, mmWave hybrid couplers as described herein can be used for signal routing, phase adjustment, and polarization control to maximize the efficiency and reliability of high-frequency satellite links. In point-to-point microwave links used for wireless backhaul, mmWave hybrid couplers such as based on the example design described herein enable the efficient distribution and combination of signals over the millimeter-wave spectrum, facilitating high-capacity data transmission over long distances. For both terrestrial and space applications, mmWave hybrid couplers as described and represented herein can be integral to phased array antenna systems, allowing for dynamic beam shaping and steering by controlling the phase and amplitude of signals fed into the antenna elements.

One or more example embodiments can be embodied in a quadrature coupler, such as described and represented herein. The quadrature coupler can include a top metallization layer. The top metallization layer can include a metallic upper plane, a first port coupled to the metallic upper plane via a first microstrip line, a second port coupled to the metallic upper plane via a second microstrip line, a third port coupled to the metallic upper plane via a third microstrip line, and a fourth port coupled to the metallic upper plane via a fourth microstrip line, wherein the first port is opposite the third port, the first port is adjacent to the second port, and the first port is the adjacent to fourth port. The top metallization layer further can include a first slot in the metallic upper plane having a first slot width and a first slot length, and a second slot in the metallic upper plane having a second slot width and a second slot length, in which the first slot crosses the second slot at an intersection point. The quadrature coupler further can include a bottom metallization layer comprising a ground plane, and a substrate between the top metallization layer and the bottom metallization layer. A size of the quadrature coupler, the first slot width, the first slot length, the second slot width, and the second slot length, can determine radio frequency characteristics of the quadrature coupler, in which the radio frequency characteristics include a defined bandwidth around a center frequency.

The first slot can be angled at substantially about forty-five degrees relative to the first microstrip line and the third microstrip line, and the second slot can be substantially perpendicular to the first slot.

The first slot length can be greater than the second slot length.

The metallic upper plane can be substantially square, and the intersection point of the first slot and the second slot can be substantially centered relative to the metallic upper plane.

At least one of: the first slot width, the first slot length, the second slot width, or the second slot length, can be defined at least in part based on a material of the substrate.

At least one of: the first slot width, the first slot length, the second slot width, or the second slot length, can be determined at least in part based on radio frequency matching of the quadrature coupler.

The scattering parameters of the quadrature coupler can be determined at least in part by at least one of: the first slot width, the first slot length, the second slot width, or the second slot length.

The defined bandwidth of the quadrature coupler can be determined at least in part by at least one of: the first slot width, the first slot length, the second slot width, or the second slot length.

The center frequency of the quadrature coupler can be determined by the size of the quadrature coupler.

Respective length and width dimensions of the first port, the second port, the third port, and the fourth port can determine a characteristic impedance of the quadrature coupler.

The top metallization layer and the bottom metallization layer can form a coplanar waveguide without an interconnecting layer between the top metallization layer and the bottom metallization layer.

The defined bandwidth can be greater than around three gigahertz at a center frequency greater than around fifteen gigahertz.

One or more example embodiments can be embodied in a device, such as described and represented herein. The device can include a quadrature coupler, which can include a single top metallization layer, a substrate beneath the single top metallization layer, and a single ground plane metallization layer beneath the substrate. The single top metallization layer can include an upper metallic plane portion, a first pair of opposite ports coupled to the upper metallic plane portion at first opposite sides of the upper metallic plane portion, a second pair of opposite ports coupled to the upper metallic plane portion at second opposite sides of the upper metallic plane portion, and an opening in the upper metallic plane portion comprising a first slot and a second slot, wherein the first slot and the second slot form a cross-shaped pattern that intersects at an intersection point.

The quadrature coupler can be incorporated into a beamforming network.

The upper metallic plane portion can be substantially square, the intersection point can be substantially centered relative to the upper metallic plane portion, the first slot can be substantially diagonal between two opposite corners of the upper metallic plane portion, and the second slot can be substantially perpendicular to the first slot.

The first slot can include a first slot width and a first slot length, the second slot can include a second slot width and a second slot length, and the first slot width, the first slot length, the second slot width and the second slot length can determine radio frequency characteristics of the quadrature coupler.

A size of the quadrature coupler can determine a center frequency of the quadrature coupler.

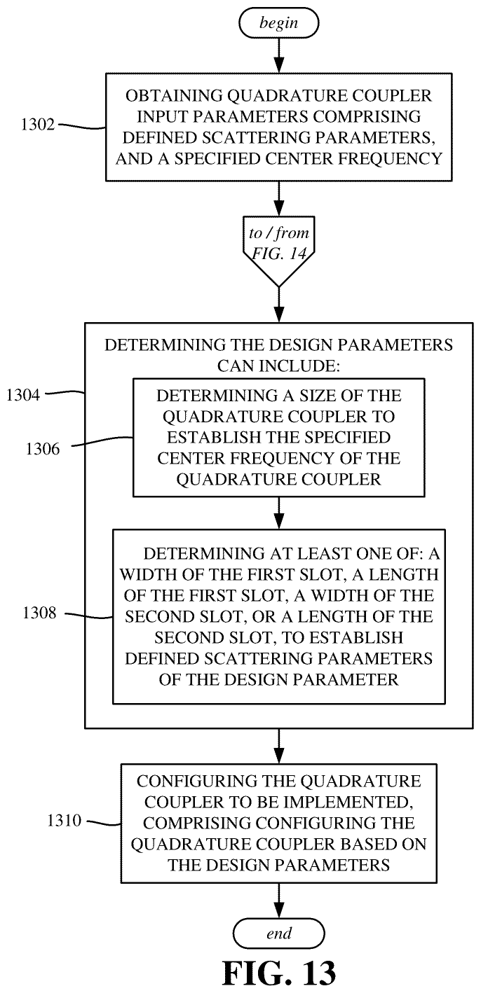

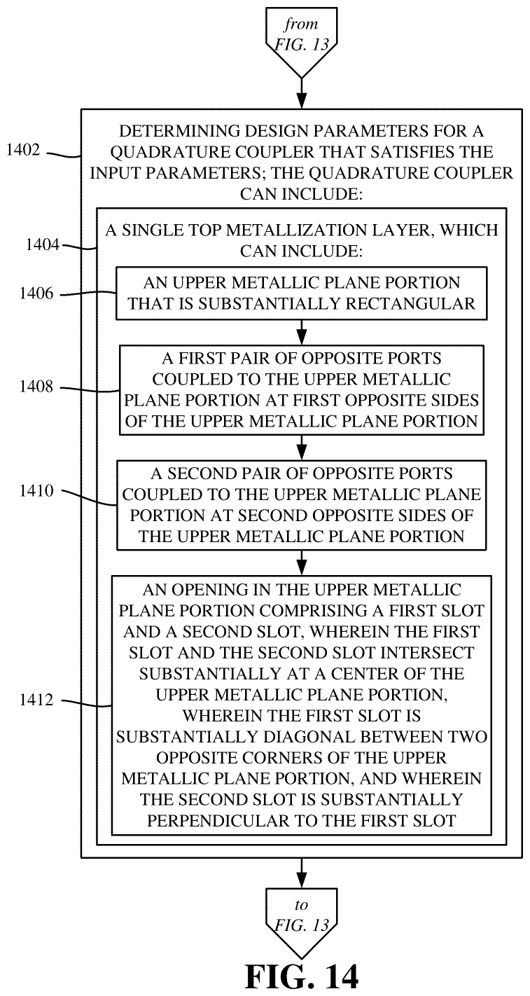

FIGS. 13 and 14 summarize various example operations, e.g., corresponding to a method, a computer-implemented system, and/or a machine-readable medium, including executable instructions that, when executed by a processor, that, when executed by at least one processor, facilitate performance of operations. Example operation 1302 represents obtaining quadrature coupler input parameters comprising defined scattering parameters, and a specified center frequency. The operations continue at example operation 1402 of FIG. 14, which represents determining design parameters for a quadrature coupler that satisfies the input parameters. The quadrature coupler can include a single top metallization layer (block 1404), which can include an upper metallic plane portion that is substantially rectangular (block 1406). The single top metallization layer (block 1404) can further include example blocks 1408, 1410 and 1412. Block 1408 represents a first pair of opposite ports coupled to the upper metallic plane portion at first opposite sides of the upper metallic plane portion. Block 1410 represents a second pair of opposite ports coupled to the upper metallic plane portion at second opposite sides of the upper metallic plane portion. Block 1412 represents an opening in the upper metallic plane portion comprising a first slot and a second slot, in which the first slot and the second slot intersect substantially at a center of the upper metallic plane portion, in which the first slot is substantially diagonal between two opposite corners of the upper metallic plane portion, and in which the second slot is substantially perpendicular to the first slot. The operations return to FIG. 13, in which example operation 1304 represents determining the design parameters, which can include determining a size of the quadrature coupler to establish the specified center frequency of the quadrature coupler (example operation 1306), and determining at least one of: a width of the first slot, a length of the first slot, a width of the second slot, or a length of the second slot, to establish defined scattering parameters of the design parameters (example operation 1308). Example operation 1304 represents configuring the quadrature coupler to be implemented, comprising configuring the quadrature coupler based on the design parameters.

Obtaining the quadrature coupler input parameters can include obtaining a substrate permittivity, and determining the design parameters further can include determining at least one of: the width of the first slot, the length of the first slot, the width of the second slot, or the length of the second slot, at least in part, to establish the defined scattering parameters based on the substrate permittivity.

Obtaining the quadrature coupler input parameters can include obtaining a characteristic impedance, and determining the design parameters further can include determining length and width dimensions of the first pair of opposite ports, and length and width dimensions of the second pair of opposite ports, at least in part, to establish the characteristic impedance of the quadrature coupler.

As can be seen, the technology described herein is directed to a quadrature coupler, including one implementation that uses a single top metallization layer, is passive, and does not require any interconnecting layer. The quadrature coupler is fully scalable, having low insertion loss at millimeter-wave frequencies, achieved by using a cross-shaped slots in the middle of the coupler for efficiently routing E- and H-fields to other available ports. The quadrature coupler is a broadband coupler with constant bandwidth, which helps designers easily scale the coupler to a desired frequency, without requiring any computation-heavy optimization. One result is an ultra-low-cost solution for mmWave circuits and systems, without any stringent dimensional variabilities.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A quadrature coupler, comprising:
a top metallization layer, comprising:
a metallic upper plane,
a first port coupled to the metallic upper plane via a first microstrip line, a second port coupled to the metallic upper plane via a second microstrip line, a third port coupled to the metallic upper plane via a third microstrip line, and a fourth port coupled to the metallic upper plane via a fourth microstrip line, wherein the first port is opposite the third port, the first port is adjacent to the second port, and the first port is the adjacent to fourth port,
a first slot in the metallic upper plane having a first slot width and a first slot length,
a second slot in the metallic upper plane having a second slot width and a second slot length, wherein the first slot crosses the second slot at an intersection point;
a bottom metallization layer comprising a ground plane; and
a substrate between the top metallization layer and the bottom metallization layer,
wherein a size of the quadrature coupler, the first slot width, the first slot length, the second slot width, and the second slot length, determine radio frequency characteristics of the quadrature coupler, the radio frequency characteristics comprising a defined bandwidth around a center frequency.

2. The quadrature coupler of claim 1, wherein the first slot is angled at substantially about forty-five degrees relative to the first microstrip line and the third microstrip line, and wherein the second slot is substantially perpendicular to the first slot.

3. The quadrature coupler of claim 1, wherein the first slot length is greater than the second slot length.

4. The quadrature coupler of claim 1, wherein the metallic upper plane is substantially square, and wherein the intersection point of the first slot and the second slot is substantially centered relative to the metallic upper plane.

5. The quadrature coupler of claim 1, wherein at least one of: the first slot width, the first slot length, the second slot width, or the second slot length, is defined at least in part based on a material of the substrate.

6. The quadrature coupler of claim 1, wherein at least one of: the first slot width, the first slot length, the second slot width, or the second slot length, is determined at least in part based on radio frequency matching of the quadrature coupler.

7. The quadrature coupler of claim 1, wherein scattering parameters of the quadrature coupler are determined at least in part by at least one of: the first slot width, the first slot length, the second slot width, or the second slot length.

8. The quadrature coupler of claim 1, wherein the defined bandwidth of the quadrature coupler is determined at least in part by at least one of: the first slot width, the first slot length, the second slot width, or the second slot length.

9. The quadrature coupler of claim 1, wherein the center frequency of the quadrature coupler is determined by the size of the quadrature coupler.

10. The quadrature coupler of claim 1, wherein respective length and width dimensions of the first port, the second port, the third port, and the fourth port determine a characteristic impedance of the quadrature coupler.

11. The quadrature coupler of claim 1, wherein the top metallization layer and the bottom metallization layer form a coplanar waveguide without an interconnecting layer between the top metallization layer and the bottom metallization layer.

12. The quadrature coupler of claim 1, wherein the defined bandwidth is greater than around three gigahertz at a center frequency greater than around fifteen gigahertz.

13. A device, comprising:
a quadrature coupler, comprising:
a single top metallization layer,
a substrate beneath the single top metallization layer, and
a single ground plane metallization layer beneath the substrate,
wherein the single top metallization layer comprises:
an upper metallic plane portion,
a first pair of opposite ports coupled to the upper metallic plane portion at first opposite sides of the upper metallic plane portion,
a second pair of opposite ports coupled to the upper metallic plane portion at second opposite sides of the upper metallic plane portion, and
an opening in the upper metallic plane portion comprising a first slot and a second slot, wherein the first slot and the second slot form a cross-shaped pattern that intersects at an intersection point.

14. The device of claim 13, wherein the quadrature coupler is incorporated into a beamforming network.

15. The device of claim 13, wherein the upper metallic plane portion is substantially square, wherein the intersection point is substantially centered relative to the upper metallic plane portion, wherein the first slot is substantially diagonal between two opposite corners of the upper metallic plane portion, and wherein the second slot is substantially perpendicular to the first slot.

16. The device of claim 13, wherein the first slot comprises a first slot width and a first slot length, wherein the second slot comprises a second slot width and a second slot length, and wherein the first slot width, the first slot length, the second slot width and the second slot length determine radio frequency characteristics of the quadrature coupler.

17. The device of claim 13, wherein a size of the quadrature coupler determines a center frequency of the quadrature coupler.

18. A non-transitory machine-readable medium, comprising executable instructions that, when executed by at least one processor, facilitate performance of operations, the operations comprising:
obtaining quadrature coupler input parameters comprising defined scattering parameters, and a specified center frequency;
determining design parameters for a quadrature coupler that satisfies the input parameters, the quadrature coupler comprising:
a single top metallization layer, comprising:
an upper metallic plane portion that is substantially rectangular;
a first pair of opposite ports coupled to the upper metallic plane portion at first opposite sides of the upper metallic plane portion,
a second pair of opposite ports coupled to the upper metallic plane portion at second opposite sides of the upper metallic plane portion,
an opening in the upper metallic plane portion comprising a first slot and a second slot, wherein the first slot and the second slot intersect substantially at a center of the upper metallic plane portion, wherein the first slot is substantially diagonal between two opposite corners of the upper metallic plane portion, and
wherein the second slot is substantially perpendicular to the first slot;
wherein the determining of the design parameters comprises,
determining a size of the quadrature coupler to establish the specified center frequency of the quadrature coupler, and
determining at least one of: a width of the first slot, a length of the first slot, a width of the second slot, or a length of the second slot, to establish defined scattering parameters of the design parameters; and
configuring the quadrature coupler to be implemented, comprising configuring the quadrature coupler based on the design parameters.

19. The non-transitory machine-readable medium of claim 18, wherein the obtaining of the quadrature coupler input parameters comprises obtaining a substrate permittivity, and wherein the determining of the design parameters further comprises determining at least one of: the width of the first slot, the length of the first slot, the width of the second slot, or the length of the second slot, at least in part, to establish the defined scattering parameters based on the substrate permittivity.

20. The non-transitory machine-readable medium of claim 18, wherein the obtaining of the quadrature coupler input parameters comprises obtaining a characteristic impedance, and wherein the determining of the design parameters further comprises determining length and width dimensions of the first pair of opposite ports, and length and width dimensions of the second pair of opposite ports, at least in part, to establish the characteristic impedance of the quadrature coupler.
